(19) United States
(12) Patent Application Publication
(10) Pub. No.: US 2026/0178189 A1
(43) Pub. Date: Jun. 25, 2026

(54) DISPLAY CONTROL DEVICE, DISPLAY CONTROL METHOD, AND STORAGE MEDIUM

(71) Applicant: TOYOTA JIDOSHA KABUSHIKI KAISHA, Toyota-shi Aichi-ken (JP)

(72) Inventor: Satoshi Naito, Yokohama-shi Kanagawa-ken (JP)

(73) Assignee: TOYOTA JIDOSHA KABUSHIKI KAISHA, Toyota-shi Aichi-ken (JP)

(21) Appl. No.: 19/429,102

(22) Filed: Dec. 22, 2025

(30) Foreign Application Priority Data
Dec. 24, 2024 (JP) 2024-227445

(51) Int. Cl. G06F 3/04886; B60K 35/10; B60K 35/81; G06F 3/0482; G06F 3/04847

(52) U.S. Cl. CPC G06F 3/04886; G06F 3/0482; G06F 3/04847; B60K 35/10; B60K 35/81; B60K 2360/11

(57) ABSTRACT

Functions assigned to the short cut buttons displayed on the basic screen of the display device are comprised of either one of the compulsory setting type of functions and the setting hold type functions. The short cut buttons to which the compulsory setting type functions are assigned are displayed on the basic screen of the display device when the power of the vehicle is turned on and, when the on/off settings of the compulsory setting type functions are changed after the power of the vehicle is turned on and before the power of the vehicle is turned off, the short cut buttons 35, 36) to which the compulsory setting type functions are assigned are kept from being displayed until the power of the vehicle is turned off.

### CROSS-REFERENCE TO RELATED APPLICATIONS

This application claims priority to Japanese Patent Application No. 2024-227445 filed Dec. 24, 2024, the entire contents of which are herein incorporated by reference.

### FIELD

The present disclosure relates to a display control device, display control method, and storage medium.

### BACKGROUND

Known in the art is an information apparatus designed to display vehicle function buttons, that is, short cut buttons, for calling up specific functions relating to operation of a vehicle, on a menu screen of a display device mounted in the vehicle (for example, see Japanese Unexamined Patent Publication No. 2024-49711). This information apparatus is designed to acquire the frequencies of use of the different functions relating to operation of the vehicle separated into use while the vehicle is moving and while the vehicle is stopped, display function buttons, that is, short cut buttons, for calling up functions judged to be high in frequency of use while the vehicle was moving when the vehicle is moving, and display function buttons, that is, short cut buttons, for calling up functions judged to be high in frequency of use while the vehicle was stopped when the vehicle is stopped.

### SUMMARY

In this regard, in a vehicle, there are functions where the on/off settings thereof are performed by short cut buttons being pressed by a user with a high probability when the power of the vehicle is turned on, but once the short cut buttons are pressed, after that the on/off settings thereof will not be changed until the power of the vehicle is turned off. On the other hand, the functions of a vehicle include compulsory setting type functions which are compulsorily set on/off when the power of the vehicle is turned on regardless of the on/off settings of the functions when the power was turned off the previous time and setting hold type functions where the on/off settings of the functions when the power was turned off the previous time are held at the time when the power of the vehicle is turned on. In particular, the compulsory setting type functions has a strong tendency such that, if the on/off settings of the functions are performed by short cut buttons being pressed once when the power of the vehicle is turned on, after that, the on/off settings of the functions are not changed until the power of the vehicle is turned off. In embodiments, in this case, the short cut buttons for the compulsory setting type functions the on/off settings of which are performed by a high probability when the power of the vehicle is turned on are displayed from the start. However, if, like in the above known information apparatus, making short cut buttons be displayed based on the history of use, there is the problem that short cut buttons will not be displayed until a history of use is built up and therefore a user has to repeatedly perform a burdensome operation for display of short cut buttons.

The present disclosure is designed to make a short cut button to which the compulsory setting type function is assigned be displayed when the power is turned on and then keep the short cut button to which the compulsory setting type function is assigned from being displayed when the on/off setting of the compulsory setting type function is changed.

According to the present disclosure, there is provided a display control device for controlling a screen display of a display device mounted in a vehicle, the display control device comprising:
a short cut button display control unit for making short cut buttons be displayed on a basic screen of the display device
functions assigned to the short cut buttons being comprised of either compulsory setting type functions which are compulsorily set on or off when a power of the vehicle is turned on regardless of on/off settings of the functions when the power was turned off the previous time and setting hold type functions where the on/off settings of the functions when the power was turned off the previous time are held when the power of the vehicle is turned on,
the short cut button display control unit making the short cut buttons to which the compulsory setting type functions are assigned be displayed on the basic screen of the display device when the power of the vehicle is turned on and keeping the short cut buttons to which the compulsory setting type functions are assigned from being displayed on the basic screen of the display device until the power of the vehicle is turned off when the on/off settings of the compulsory setting type functions are changed after the power of the vehicle is turned on and before the power of the vehicle is turned off.

Furthermore, according to the present disclosure, there is provided a display control method for controlling a screen display of a display device mounted in a vehicle, in which functions assigned to short cut buttons which are displayed on a basic screen of the display device is comprised of either compulsory setting type functions which are compulsorily set on or off when a power of the vehicle is turned on regardless of on/off settings of the functions when the power was turned off the previous time and setting hold type functions where the on/off settings of the functions when the power was turned off the previous time are held when the power of the vehicle is turned on,
the display control method causing a computer to
make the short cut buttons to which the compulsory setting type functions are assigned be displayed on the basic screen of the display device when the power of the vehicle is turned on and
keep the short cut buttons to which the compulsory setting type functions are assigned from being displayed on the basic screen of the display device until the power of the vehicle is turned off when the on/off settings of the compulsory setting type functions are changed after the power of the vehicle is turned on and before the power of the vehicle is turned off.

Furthermore, according to the present disclosure, there is provided a storage medium storing a program used for controlling a screen display of a display device mounted in a vehicle, in which functions assigned to short cut buttons which are displayed on a basic screen of the display device is comprised of either compulsory setting type functions which are compulsorily set on or off when a power of the vehicle is turned on regardless of on/off settings of the functions when the power was turned off the previous time and setting hold type functions where the on/off settings of the functions when the power was turned off the previous time are held when the power of the vehicle is turned on,
the program causing a computer to
make the short cut buttons to which the compulsory setting type functions are assigned be displayed on a basic screen of the display device when the power of the vehicle is turned on and
keep the short cut buttons to which the compulsory setting type functions are assigned from being displayed on the basic screen of the display device until the power of the vehicle is turned off when the on/off settings of the compulsory setting type functions are changed after the power of the vehicle is turned on and before the power of the vehicle is turned off.

By preventing the short cut button which if once touched, will never be touched again, from being displayed, a user can easily find other necessary buttons.

### BRIEF DESCRIPTION OF DRAWINGS

FIG. 1 is a top view of a vehicle shown schematically.

FIG. 2 is a view showing a functional configuration of a vehicle.

FIG. 3A is a view schematically showing a basic screen of a display device.

FIG. 3B is another view schematically showing a basic screen of a display device.

FIG. 4A is a view schematically showing a scree of a display device.

FIG. 4B is another view schematically showing a screen of a display device.

FIG. 5A is a view schematically showing a scree of a display device.

FIG. 5B is another view schematically showing a screen of a display device.

FIG. 6 is a flow chart for performing processing for setting compulsory setting type functions on/off when the power is turned on.

FIG. 7 is a flow chart for performing processing for displaying short cut buttons.

FIG. 8 is a flow chart for performing processing for setting functions on/off without using short cut buttons.

FIG. 9 is a flow chart for performing processing for setting functions on/off by using short cut buttons.

FIG. 10 is a flow chart for performing processing for setting functions on/off by using short cut buttons.

FIG. 11 is a flow chart for performing processing for calculating the frequency of use of a function.

FIG. 12 is a view schematically showing basic screen of a display device.

FIG. 13 is a view schematically showing a screen of a display device.

### DESCRIPTION OF EMBODIMENTS

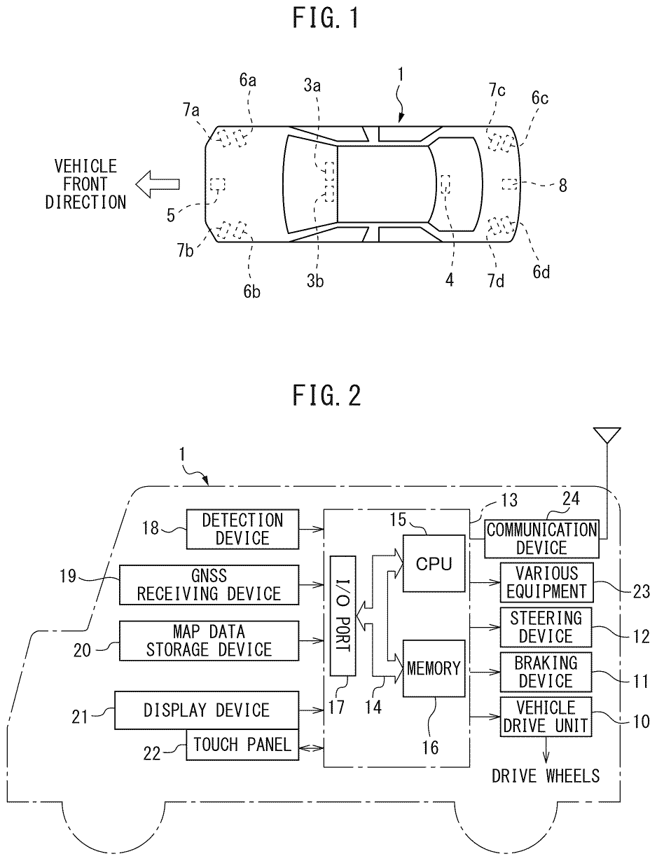

FIG. 1 schematically shows a vehicle 1 when viewed from above, while FIG. 2 shows the functional configuration of the vehicle 1 shown in FIG. 1. Note that, this vehicle 1 can be driven by either manual driving and autonomous driving. If referring to FIG. 2, 10 indicates a vehicle drive unit for imparting drive force to drive wheels of the vehicle 1, 11 indicates a braking device for braking the vehicle 1, 12 indicates a steering device for steering the vehicle 1, and 13 indicates an electronic control unit mounted in the vehicle 1. As shown in FIG. 2, the electronic control unit 13 is comprised of a digital computer and is provided with a CPU (processor) 15, a memory 16 comprised of a ROM and RAM, and an input/output port 17 which are connected with each other by a bidirectional bus 14.

On the other hand, as shown in FIG. 2, in the vehicle 1, a detection device 18 including various types of sensors required when the vehicle 1 is being manually driven or automatically driven is arranged. This detection device 18 includes sensors for detecting the state of the vehicle 1 and sensors for detecting the surroundings of the vehicle 1. In this case, as sensors for detecting the state of the vehicle 1, an acceleration sensor, speed sensor, azimuth sensor, and geomagnetic sensor are used. As sensors for detecting the surroundings of the vehicle 1, cameras for capturing the areas in front of, at the sides of, and at the back of the vehicle 1, and lidars, radars, clearance sonars, etc. for detecting the areas in front of, at the sides of, and at the back of the vehicle 1 are used.

FIG. 1 shows one example of the sensors arranged in the vehicle 1. In the example shown in FIG. 1, visible light cameras 3a, 3b for capturing the area in front of the vehicle 1, a rear camera 4 for capturing the area in back of the vehicle 1, a long distance millimeter wave radar 5 for emitting millimeter waves toward the area in front of the vehicle 1, medium distance millimeter wave radars 6a, 6b, 6c, and 6d for emitting millimeter waves toward the areas at the sides of the vehicle 1, lidars 7a, 7b, 7c, and 7d for firing laser beams toward the areas at the sides of the vehicle 1, and clearance sonar 8 for emitting ultrasonic waves toward the area in back of the vehicle 1 are arranged in the vehicle 1. Note that, the method of setting the cameras and sensors shown in FIG. 1 shown is just an example. There are various methods for arranging these cameras and sensors.

Returning again to FIG. 2, the vehicle 1 is provided with a GNSS (global navigation satellite system) receiving device 19, map data storage device 20, and display device 21. The GNSS receiving device 19 can detect a current position of the vehicle 1 (for example, the latitude and longitude of the vehicle 1) based on information obtained from a plurality of artificial satellites. Therefore, it is possible to acquire the current position of the vehicle 1 by this GNSS receiving device 19. As this GNSS receiving device 19, for example, a GPS receiving device is used. Further, in the map data storage device 20, the map data etc. necessary for the vehicle 1 to run is stored. The detection device 18, the GNSS receiving device 19, and the map data storage device 20 are connected to the electronic control unit 13.

The display device 21 is arranged inside the vehicle compartment and has a screen able to be viewed by the user of the vehicle 1, for example, the driver of the vehicle 1. A pressure sensitive type, electrostatic inductance type, or electrostatic capacity type thin film shaped touch panel 22 is integrally formed on the screen of the display device 21. These display device 21 and touch panel 22 are connected to the electronic control unit 13. Further, headlights, turn lights, inside compartment lights, an air-conditioner, and other various devices 23 are arranged in the vehicle 1. These various devices 23 are connected to the electronic control unit 13. A communication device 24 for receiving television broadcasts, radio broadcasts, traffic information, etc. and trading signals with information centers or other vehicles is mounted in the vehicle 1. This communication device 24 is connected to the electronic control unit 13.

In the example shown in FIG. 2, the vehicle drive unit 10 of the vehicle 1 is comprised of an electric motor driven by a secondary battery or an electric motor driven by a fuel cell. The drive wheels are controlled in drive by these electric motors in accordance with output signals of the electronic control unit 13. Further, the braking of the vehicle 1 is controlled by the braking device 11 in accordance with output signals of the electronic control unit 13, while the steering of the vehicle 1 is controlled by the steering device 12 in accordance with output signals of the electronic control unit 13.

First, the meanings of the terms used in this Description will be simply explained.

In this Description, “power on” indicates “a state where the vehicle 1 can be controlled in drive” while “power off” indicates “a state where the vehicle 1 cannot be controlled in drive”. Further, in this Description, “function on” indicates “a state where a function is activated or a state where a function can be activated” while “function off” indicates “a state where a function is deactivated”.

Further, in this Description, “a function is set on” indicates “a function is set so that the function is activated” while “a function is set off” indicates “a function is set so that the function is deactivated”.

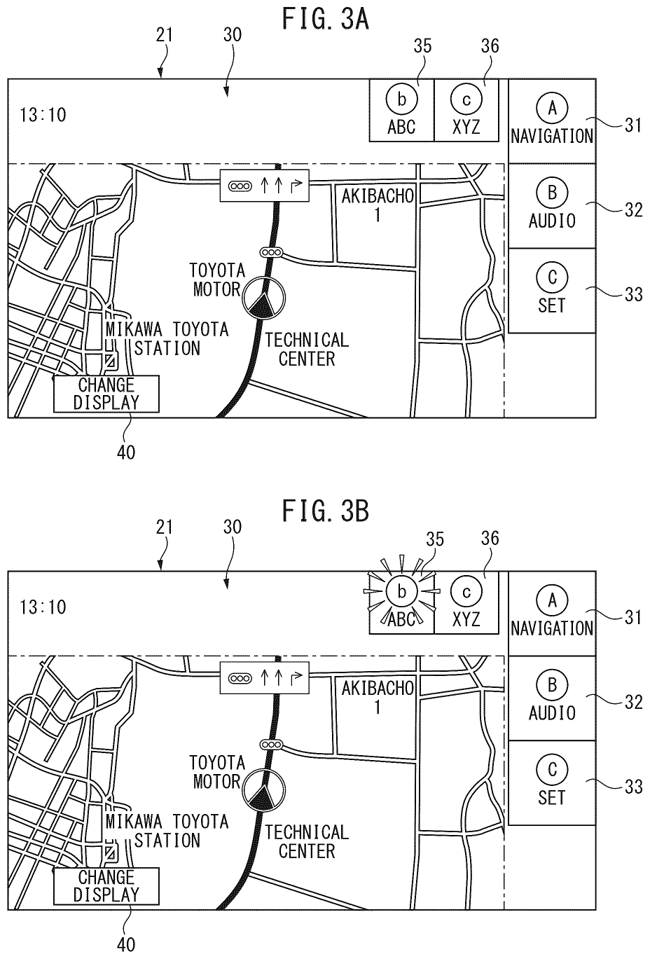

Next, referring to FIG. 3A, the screen 30 of the display device 21 used in an embodiment according to the present disclosure will be explained. If the display device 21 is started up, as shown in FIG. 3A, a button 31 for a navigation function which is one of the basic functions, a button 32 for an audio function which is one of the basic functions, and a button 33 for a setting function which is one of the basic functions are displayed on the surroundings of the screen 30 of the display device 21. At this time, as shown in FIG. 3A, for example, a road map is displayed on the screen 30 of the display device 21. In this Description, the screen 30 on which the button 31 for a navigation function which is one of the basic functions, the button 32 for an audio function which is one of the basic functions, and the button 33 for a setting function which is one of the basic functions are displayed like when the display device 21 is started up will be called a “basic screen”.

Note that, in the embodiment shown in FIG. 3A, a layer of the thin film shaped touch panel 22 is formed on the screen 30 of the display device 21. In FIG. 3A, if buttons displayed on the screen 30 such as the navigation function button 31, audio function button 32, and setting function button 33 are touched, the fact of the buttons being touched is recognized by the electronic control unit 13 through the touch panel 22. In this Description, the fact of buttons being displayed on the screen 30 so that the fact of buttons being touched is recognized by the electronic control unit 13 will be referred to simply as the buttons being displayed on the screen 30. Note that, in FIG. 3A, the marks A, B, C and letters illustrate schematically icons showing the navigation function, audio function, and setting function.

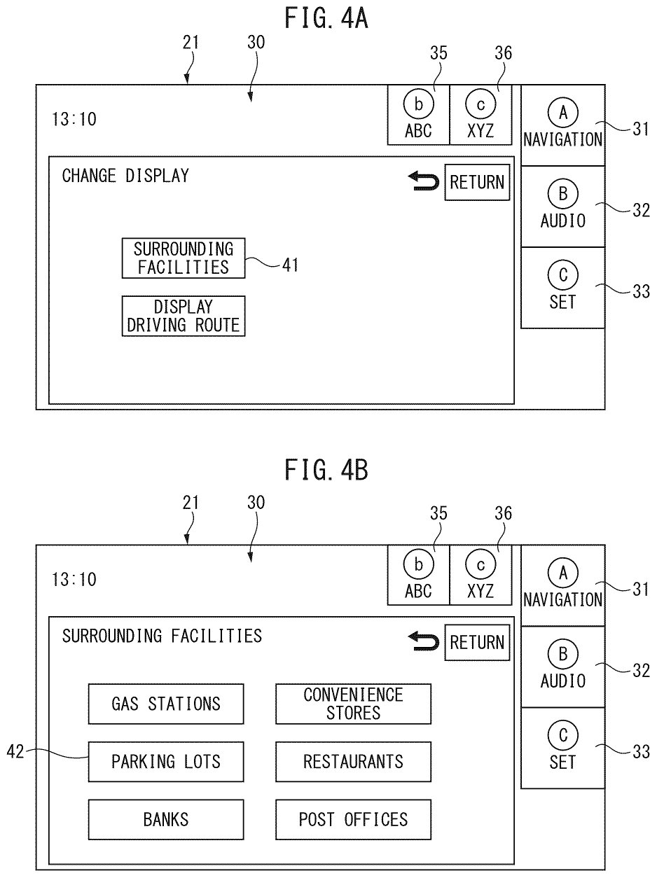

Next, one example of the button operation in these basic functions will be simply explained. FIG. 3A shows the case where the navigation function button 31 is touched and a road map is displayed on the basic screen of the display device 21. If a display changing button 40 provided on this road map is touched, the road map is switched to a display changing screen such as shown in FIG. 4A positioned one level lower. Next, if, for example, a surrounding facility button 41 which is displayed on this display changing screen is touched, the display changing screen is switched to a surrounding facility selection screen such as shown in FIG. 4B positioned one level lower. Next, if, for example, a parking lot button 42 which is displayed on this surrounding facility selection screen is touched, the screen 30 is switched to the road map screen shown in FIG. 3A and the positions of parking lots are displayed on the road map.

In this way, in this example, by the parking lot button 42 positioned at a deep level being touched, the parking lot position display function for displaying the positions of parking lots on the map is set on, the parking lot position display function is activated, and the positions of parking lots are displayed on the road map. In this case, for example, when the positions of parking lots are displayed on the road map, if the navigation function button 31 is touched, the parking lot position display function is set off and the display of the positions of the parking lots disappears from this road map. Note that, the road map screen, display changing screen, and surrounding facility selection screen respectively shown in FIG. 3A, FIG. 4A, and FIG. 4B usually have several other buttons displayed, but in FIG. 3A, FIG. 4A, and FIG. 4B, display of these several other buttons is omitted.

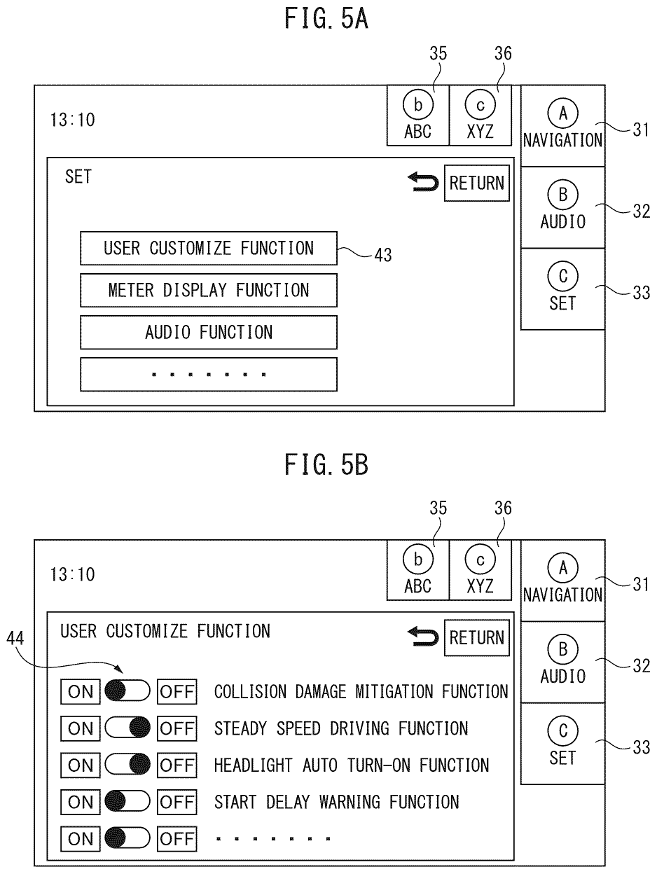

On the other hand, when, for example, the road map is displayed on the basic screen of the display device 21 such as shown in FIG. 3A, if the setting button 33 is touched, the road map is switched to the setting screen such as shown in FIG. 5A positioned one level lower. Next, if, for example, a user customize function button 43 displayed on this setting screen is touched, the setting screen is switched to the user customize function selection screen such as shown in FIG. 5B positioned one further level lower. In the example shown in FIG. 5B, an on-off display 44 is displayed on the user customize function selection screen for showing whether respective functions are currently on or off.

Here, if simply explaining the functions displayed on the user customize function selection screen, a collision damage mitigating function is a function of using the braking device 11 to impart a braking force to the vehicle 1 when a state where the vehicle 1 approaches another vehicle from the rear is detected by the detection device 18, a steady speed running function is a function of making the vehicle 1 run at a steady speed which is set, a headlight auto turn-on function is a function of automatically turning on the headlights when the brightness of the surroundings becomes a threshold value or less, and a start delay warning function is a function of issuing a warning when for example the vehicle 1 continues to be stopped despite another vehicle stopped in front of the vehicle 1 starting to move. Note that, in FIG. 5A and FIG. 5B, the expression “ . . . ” means there is a description, but details of the description are omitted. The same is true below.

That is, the functions described in FIG. 5B are just part of the functions listed on the user customize function selection screen. In actuality, the user customize function selection screen displays a far greater number of functions. In FIG. 5B, for example, if focusing on the headlight auto turn-on function, currently the headlight auto turn-on function is deactivated as will be understood from the on/off display 44. That is, the headlight auto turn-on function is set off. In this case, if touching the ON button of the headlight auto turn-on function, the headlight auto turn-on function changes from the off setting to the on setting and the on/off display 44 changes to show an on setting. In this way, in this example, by touching the corresponding button on the user customize function selection screen positioned at the deepest level, it is possible to switch all of the functions from the off setting to the on setting or switch them from the on setting to the off setting.

In this way, the buttons for setting functions on or setting them off are positioned at the deep level. However, in this way, if buttons are positioned at the deep level, time is taken for operating the buttons. In particular, if buttons of functions often utilized by a user are positioned at the deep level, for the user, operation of the button becomes considerably burdensome. Therefore, to lighten the burden on the user, in an embodiment according to the present disclosure, as shown in FIG. 3A, two short cut buttons 35, 36 for operation to which respectively different functions are assigned are displayed on the basic screen of the display device 21. Of course, three or more of such short cut buttons can also be displayed, but below, an embodiment according to the present disclosure will be explained with reference to an example of a case where two short cut buttons 35, 36 are displayed. Note that, in FIG. 3A, the marks “b”, “c” and letters ABC, XYZ schematically show icons.

In an embodiment according to the present disclosure, if touching the short cut button 35, when the function assigned to the short cut button 35 is currently set off, it is switched to an on setting. Due to this, the function assigned to the short cut button 35 is activated. Next, if touching the short cut button 35 one more time, the function assigned to the short cut button 35 is switched from the on setting to the off setting whereupon the function assigned to the short cut button 35 is deactivated. That is, each time touching the short cut button 35, the on setting and off setting of the function are switched whereupon activation of the function and deactivation of the function are switched.

Similarly, if touching the short cut button 36, when the function assigned to the short cut button 36 is currently set off, it is switched to an on setting. Due to this, the function assigned to the short cut button 36 is activated. Next, if touching the short cut button 36 one more time, the function assigned to the short cut button 36 is switched from the on setting to the off setting whereupon the function assigned to the short cut button 36 is deactivated. That is, each time touching the short cut button 36, the on setting and off setting of the function are switched whereupon activation of the function and deactivation of the function are switched.

Further, in an embodiment according to the present disclosure, if touching the short cut button 35, when the function assigned to the short cut button 35 is set off, the short cut button 35 is rendered off in display, while if the function assigned to the short cut button 35 is set on, the short cut button 35 is rendered on in display. Similarly, when the function assigned to the short cut button 36 is set off, the short cut button 36 is rendered off in display, while if the function assigned to the short cut button 36 is set on, the short cut button 36 is rendered on in display.

An example when the short cut button 35 is rendered off in display and when the short cut button 35 is rendered on in display is shown in FIG. 3A and FIG. 3B. In this example, when the short cut button 35 is the same brightness as the other buttons 31, 32, and 33 as shown in FIG. 3A, the display of the short cut button 35 is deemed off in display while when the short cut button 35 as a whole shines brightly or when the icon part of the short cut button 35 shines brightly as shown in FIG. 3B, the short cut button 35 is deemed on in display. Similarly, when the short cut button 36 is the same brightness as the other buttons 31, 32, and 33, the short cut button 36 is deemed off in display, while when the short cut button 36 as a whole shines brightly or when the icon part of the short cut button 36 shines brightly, the short cut button 36 is deemed on in display.

In this way, in an embodiment according to the present disclosure, the short cut buttons 35, 36 are displayed on the basic screen of the display device 21 so that it is possible to set the functions respectively assigned to the short cut buttons 35, 36 on/off by just touching the short cut buttons 35, 36. Here, the issue becomes which functions should be assigned to the short cut buttons 35, 36 to enable the burden felt by the user to be more effectively lessened. Therefore, next, the functions desirably assigned to the short cut buttons 35, 36 will be studied.

Functions come in two types. The first type of function is a function which is set on when the power of the vehicle 1 is turned on whether the function was set on or set off when the power of the vehicle 1 was turned off the previous time or a function which is set off when the power of the vehicle 1 is turned on whether the function was set on or set off when the power of the vehicle 1 was turned off the previous time, that is, a function which is compulsorily set on or off when the power of the vehicle 1 is turned on regardless of the on/off setting of the function when the power was turned off the previous time. The second type of function is a function which is set on when the power of the vehicle is turned on if the function was set on when the power of the vehicle 1 was turned off the previous time and which is set off when the power of the vehicle 1 is turned on if the function was set off when the power of the vehicle 1 was turned off the previous time, that is, a function where an on/off setting of the function when the power was turned off the previous time are held when the power of the vehicle 1 is turned on.

Note that, in this Description, the first type of function, that is, a function which is compulsorily set on or off when the power of the vehicle 1 is turned on regardless of the on/off setting of the function when the power was turned off the previous time is called a “compulsory setting type of function”, while the second type of function, that is, a function where an on/off setting of the function when the power was turned off the previous time are held when the power of the vehicle 1 is turned on is called a “setting holding type of function”. For all functions, whether the function is the compulsory setting type function or is the setting hold type function is stored in the memory 16 of the electronic control unit 13, and if the function is the compulsory setting type function, whether to set the function on or whether to set it off when the power of the vehicle 1 is turned on is stored in the memory 16 of the electronic control unit 13.

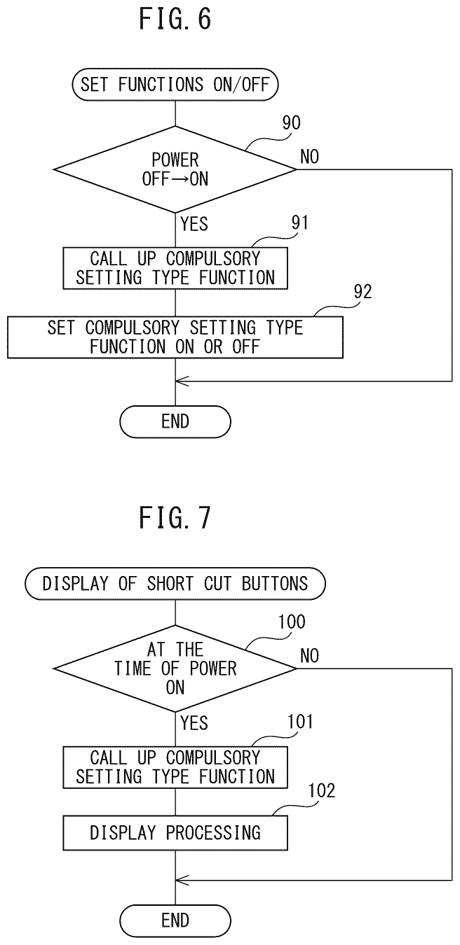

FIG. 6 shows a routine for performing processing for setting on/off of a compulsory setting type function when the power is turned on. This routine is performed repeatedly in the electronic control unit 13.

Referring to FIG. 6, first, at step 90, it is judged whether the power is switched from off to on. When it is judged that the power is switched from off to on, the routine proceeds to step 91 where all of the compulsory setting type functions are called up from the functions stored in the memory 16. Next, at step 92, all of the compulsory setting type functions are respectively set on or set off based on the information stored in the memory 16.

Now then, usually, most of the functions are made setting hold type functions while some of the functions are made compulsory setting type functions. In this case, the compulsory setting type functions sometimes are felt by the user to be burdensome. For example, assuming that the start delay warning function is made the compulsory setting type function which is compulsorily set on when the power of the vehicle 1 is turned on regardless of the on/off setting of the function when the power was turned off the previous time, when the power of the vehicle 1 is turned on, the start delay warning function is automatically set on.

Therefore, if the user of the vehicle 1 is thinking of setting the start delay warning function off, the user would have to switch the start delay warning function from the on setting to the off setting each time the power of the vehicle 1 is turned on. This is burdensome to the user. In this case, for example, if assigning in advance the start delay warning function to the short cut button 35, by just touching the short cut button 35, it would be possible to switch the start delay warning function from the on setting to the off setting, so it would be possible to lessen the burden which the user feels. Therefore, in an embodiment of the present disclosure, a compulsory setting type function, for example, a start delay warning function, is assigned to the short cut button 35 when the power of the vehicle 1 is turned on. In other words, when the power of the vehicle 1 is turned on, the short cut button 35 to which the compulsory setting type function, for example, the start delay warning function, is assigned is automatically made to be displayed on the basic screen of the display device 21. Note that in an embodiment according to the present disclosure, the function to be assigned to the short cut button 53 is selected in advance and is stored as a specific compulsory setting type function in the memory 16 of the electronic control unit 13.

FIG. 7 shows a routine for processing of display of a short cut button. This routine is performed inside the electronic control unit 13.

Referring to FIG. 7, first, at step 100, it is judged whether the power of the vehicle 1 is switched from off to on, that is, whether the power of the vehicle 1 is turned on. When it is judged that the power of the vehicle 1 is turned on, the routine proceeds to step 101 where a specific compulsory setting type function stored in the memory 16 as a function to be assigned to the short cut button 53, for example, the start delay warning function, is called up. Next, at step 102, this specific compulsory setting type function is assigned to the short cut button 53. That is, the short cut 53 to which this specific compulsory setting type function is assigned is displayed on the basic screen of the display device 21. Note that a separate specific compulsory setting type function is assigned to another short cut button 54, and the short cut button 54 to which this separate specific compulsory setting type function is assigned is displayed on the basic screen of the display device 21.

In this way, in an embodiment of the present disclosure, when the power is turned on, the short cut button 35 to which the compulsory setting type function, for example, the start delay warning function is assigned is automatically displayed on the basic screen of the display device 21, therefore by just touching the short cut button 35, it becomes possible to change the on/off setting of the compulsory setting type function assigned to the short cut button 35, for example, the delayed start warning function. For example, if the delayed start warning function which is the compulsory setting type function is set on when the power of the vehicle 1 is turned on, by just touching the short cut button 35 to which the delayed start warning function is assigned, the delayed start warning function is set off.

On the other hand, after the start delay warning function is set off after the start delay warning function was set on when the power of the vehicle is turned on, there is extremely little possibility of the short cut button 35 for the start delay warning function being touched. Therefore, almost no problem arises even if stopping the display of the short cut button 35 to which the start delay warning function is assigned. As opposed to this, if stopping display of the short cut button 35 to which the start delay warning function is assigned, the number of short cut buttons 35 displayed is reduced, therefore there is the aspect that it becomes easier to recognize the display of buttons to which other functions are assigned. Therefore, in an embodiment of the present disclosure, when the on/off setting of the start delay warning function, that is, the compulsory setting type function is changed after the power of the vehicle 1 was turned on and before the power of the vehicle is turned off, the short cut button 35 to which the compulsory setting type function is assigned is kept from being displayed on the basic screen of the display device 21 until the power of the vehicle 1 is turned off.

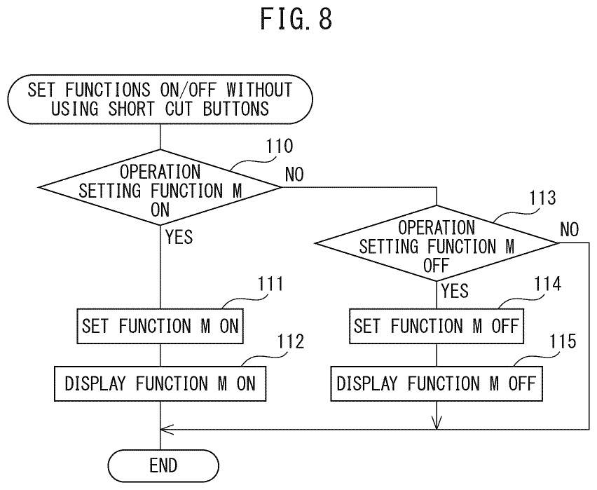

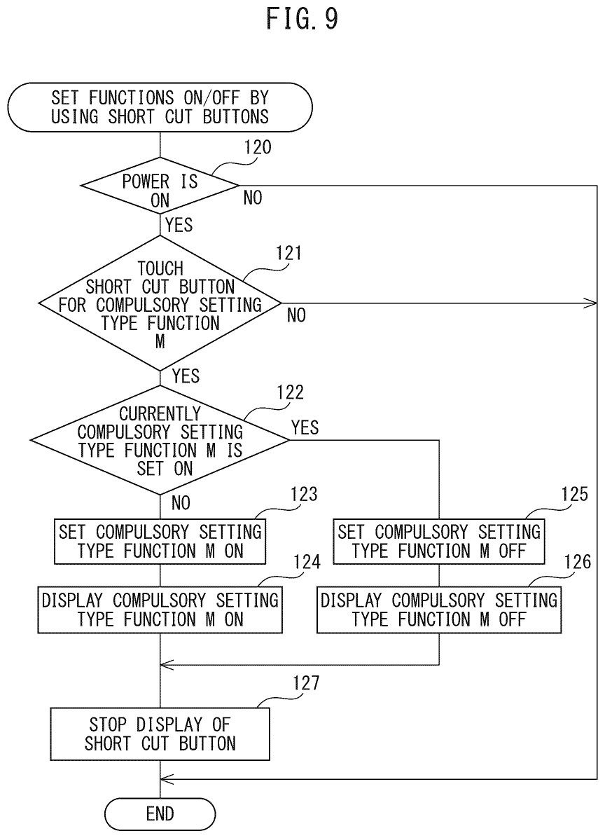

Next, referring to FIG. 8 and FIG. 9, the routine for performing processing for setting functions on/off will be explained. FIG. 8 shows a flow chart for performing processing for setting functions on/off without using short cut buttons 35, 36, and FIG. 9 shows a flow chart for performing processing for setting functions on/off by using short cut buttons 35, 36. The routines shown in FIG. 8 and FIG. 9 are provided for each function and these routines are repeatedly performed in the electronic control unit 13. Note that, a program for performing each function is stored in advance in the memory 16 of the electronic control unit 13.

Referring to FIG. 8 showing the routine for performing the processing for setting functions on/off without using the short cut buttons 35, 36, first, at step 110, it is judged whether an operation requesting activation of the function M, that is, an operation for setting the function M on has been performed by the user. For example, when the user touches the parking lot button 42 in FIG. 4B, it is judged that an operation requesting activation of the parking lot position display function for displaying positions of parking lots on the road map has been performed, that is, an operation for setting the parking lot position display function on has been performed. In this case, the function M indicates the parking lot position display function. Further, when the user touches the ON button of the headlight auto turn-on function in FIG. 5B, it is judged that an operation requesting activation of the headlight auto turn-on function for making the headlights automatically turn on when the brightness of the surroundings becomes a threshold value or less has been performed, that is, an operation for setting the headlight auto turn-on function on has been performed. In this case, the function M indicates the headlight auto turn-on function.

When, at step 110, it is judged that an operation requesting activation of the function M, that is, an operation for setting the function M on has been performed by the user, the routine proceeds to step 111 where the function Mis set on and the function M is activated. At this time, if the function M is the parking lot position display function, the parking lot position display function for displaying positions of parking lots on the road map is performed, while if the function M is the headlight auto turn-on function, the headlight auto turn-on function for making the headlights automatically turn on is performed. If the function M is set on, as shown at step 112, the function M is rendered on in display. At this time, the on/off display switch 44 of the function M shown in FIG. 5B is switched from “display off” to “display on”.

As opposed to this, when at step 110, it is judged that an operation requesting activation of the function M, that is, an operation for setting the function M on has not been performed by the user, the routine proceeds to step 113 where it is judged whether an operation for deactivation of the function M, that is, an operation for setting the function M off has been performed by the user. For example, when the positions of parking lots are displayed on the road map, if the user touches the button 31 of the navigation function, it is judged that an operation for deactivation of the parking lot position display function, that is, an operation for setting the parking lot position display function off has been performed. In this case, the “function M” indicates the parking lot position display function. Further, when the user touches the OFF button of the headlight auto turn-on function in FIG. 5B, it is judged that an operation for stopping activation of the headlight auto turn-on function has been performed, that is, an operation for setting the headlight auto turn-on function off has been performed. In this case, the “function M” indicates the headlight auto turn-on function.

When at step 113, it is judged that an operation for deactivation of the function M, that is, an operating for setting the function M off has been performed by the user, the routine proceeds to step 114 where the function M is set off and the function Mis deactivated. At this time, if the function M is the parking lot position display function, display of the positions of parking lots on the road map is stopped, and if the function Mis the headlight auto turn-on function, the headlight auto turn-on function for making the headlights automatically turn on is deactivated. If the function M is set off, as shown in step 115, the function M is rendered off in display. At this time, the on/off display switch 44 for the function M shown in FIG. 5B is switched from “display on” to “display off”. On the other hand, if, at step 113, it is judged that an operation for setting the function M off has not been performed by the user, the processing cycle is ended.

Referring to FIG. 9 showing the routine for performing the processing for setting functions on/off by using the short cut buttons 35, 36, first, at step 120, it is judged if the power of the vehicle 1 is turned on. When it is judged that the power of the vehicle 1 is turned off, the processing cycle ends. As opposed to this, when it is judged that the power of the vehicle 1 is turned on, the routine proceeds to step 121 where it is judged whether the short cut button 35 to which the compulsory setting type function M such as, for example, the start delay warning function is assigned has been touched. When it is judged that the short cut button 35 has been touched, the routine proceeds to step 122 where it is judged if currently the compulsory setting type function M is set on, that is, the compulsory setting type function M is activated. When it is judged that the compulsory setting type function Mis set off, that is, when it is judged that the compulsory setting type function M is deactivated, the routine proceeds to step 123.

At step 123, the compulsory setting type function M is set on and the compulsory setting type function M is activated. At this time, if the compulsory setting type function M is the start delay warning function, the start delay warning function is performed. If the compulsory setting type function M is set on, as shown in step 124, the compulsory setting type function Mis rendered “display on”. At this time, if the compulsory setting type function M is the start delay warning function, the on/off display switch 44 for the start delay warning function shown in FIG. 5B is switched from “display off” to “display on”, and the short cut button 35 is switched from “display off” to “display on”. Next, the routine proceeds to step 127 where the display of the short cut button 35 to which the compulsory setting type function is assigned on the basic screen of the display device 21 is stopped.

On the other hand, when, at step 122, it is judged that the compulsory setting type function M is currently set on, that is, the compulsory setting type function M is activated, the routine proceeds to step 125 where the compulsory setting type function M is set off and the compulsory setting type function Mis deactivated. At this time, if the compulsory setting type function M is the start delay warning function, the start delay warning function is deactivated. If the compulsory setting type function M is set off, as shown at step 126, the compulsory setting type function M is rendered “display off”. At this time, if the compulsory setting type function M is the start delay warning function, the on/off display switch 44 for the start delay warning function shown in FIG. 5B are switched from “display on” to “display off”, and the short cut button 35 is switched from “display on” to “display off”.

Next, the routine proceeds to step 127 where display of the short cut button 35 to which the compulsory setting type function is assigned on the basic screen of the display device 21 is stopped. On the other hand, when, at step 121, it is judged that the short cut button 35 has not been touched, the processing cycle ends. In this way, in this embodiment, when the short cut button 35 is touched, the display of the short cut button 35 on the basic screen of the display device 21 is stopped.

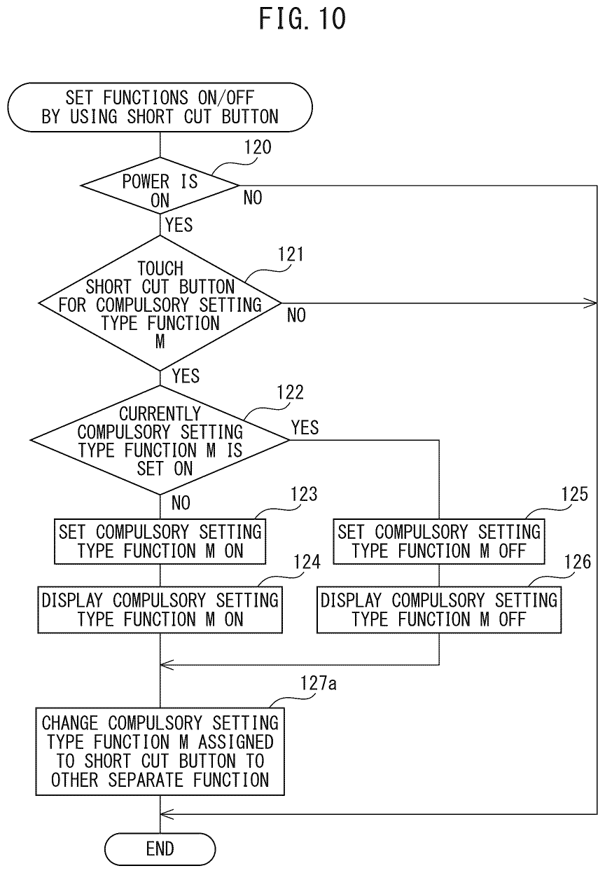

FIG. 10 shows the routine for working another embodiment of processing for setting functions on/off by using the short cut buttons 35, 36 shown in FIG. 9. This routine is also repeatedly performed inside the electronic control unit 13.

In the routine shown in FIG. 10, step 120 to step 126 are the same as step 120 to step 126 in the routine shown in FIG. 9. The routine shown in FIG. 10 differs from the routine shown in FIG. 9 on just step 127a in FIG. 10. Therefore, in the routine shown in FIG. 10, the explanation of step 120 to step 126 will be omitted and just step 127a in FIG. 10 will be explained.

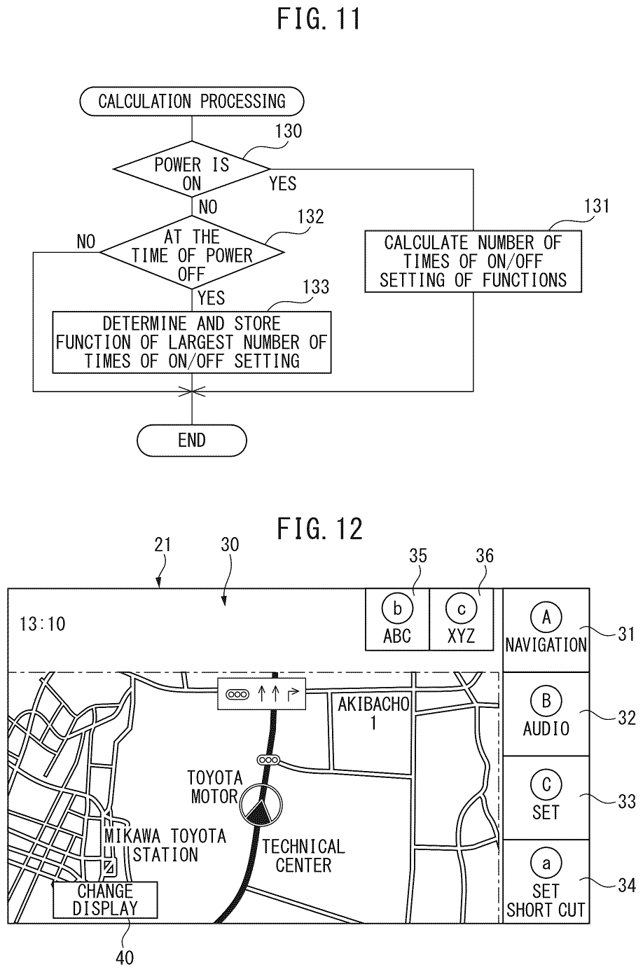

In the embodiment shown in FIG. 10, at step 127a, the function assigned to the short cut button 35 is changed from the preselected specific compulsory setting type function to a separate function and, instead of the short cut button 35 to which the preselected specific compulsory setting type function is assigned, the short cut button 35 to which the separate function is assigned is made to be displayed. This separate function may be another compulsory setting type function or may be a setting hold type function. Further, this separate function can for example be made a function with a high frequency of use. If making this separate function a function with a high frequency of use, it becomes necessary to calculate the frequency of use of the function. FIG. 11 shows the routine for processing for calculating the frequency of use of a function. This routine is repeatedly performed in the electronic control unit 13.

Referring to FIG. 11, first, at step 130, it is judged if the power of the vehicle 1 is on. When it is judged that the power of the vehicle 1 is on, the routine proceeds to step 131 where the total number of times of the function being switched from an on setting to an off setting and the times of the function being switched from an off setting to an on setting after the power of the vehicle 1 is turned on, that is, the number of times of on/off setting of the function is calculated for each function. On the other hand, when, at step 130, it is judged that the power of the vehicle 1 is turned off, the routine proceeds to step 132 where it is judged whether the power of the vehicle 1 has now been switched from on to off, that is, whether the power of the vehicle 1 is turned off or not. When it is judged that the power of the vehicle 1 is turned off, the routine proceeds to step 133 where the function with the largest number of times of on/off setting among the numbers of times of on/off settings of the functions calculated at step 131 is determined and stored in the memory 16. The function with the largest number of times of on/off setting is made the function with a high frequency of use.

In this way, in an embodiment of the present disclosure, in a display control device for controlling the screen display of the display device 21 mounted in the vehicle, the display control device comprises a short cut button display control unit for making the short cut buttons 35,36 be displayed on the basic screen of the display device 21, and the functions assigned to the short cut buttons 35,36 are comprised of either the compulsory setting type functions which are compulsorily set on or off when the power of the vehicle 1 is turned on regardless of on/off settings of the functions when the power was turned off the previous time and the setting hold type functions where the on/off settings of the functions when the power was turned off the previous time are held when the power of the vehicle 1 is turned on. The short cut button display control unit makes the short cut buttons 35,36 to which the compulsory setting type functions are assigned be displayed on the basic screen of the display device 21 when the power of the vehicle 1 is turned on and keeps the short cut buttons 35,36 to which the compulsory setting type functions are assigned from being displayed on the basic screen of the display device 21 until the power of the vehicle 1 is turned off when the on/off settings of the compulsory setting type functions are changed after the power of the vehicle 1 is turned on and before the power of the vehicle 1 is turned off.

Further, in an embodiment of the present disclosure, there is provided a display control method for controlling the screen display of the display device 21 mounted in the vehicle 1, in which the functions assigned to short cut buttons 35,36 which are displayed on the basic screen of the display device 21 is comprised of either the compulsory setting type functions which are compulsorily set on or off when the power of the vehicle 1 is turned on regardless of on/off settings of the functions when the power was turned off the previous time and the setting hold type functions where the on/off settings of the functions when the power was turned off the previous time are held when the power of the vehicle 1 is turned on. The display control method causes a computer to make the short cut buttons 35,36 to which the compulsory setting type functions are assigned be displayed on the basic screen of the display device 21 when the power of the vehicle 1 is turned on and keep the short cut buttons 35,36 to which the compulsory setting type functions are assigned from being displayed on the basic screen of the display device 1 until the power of the vehicle 1 is turned off when the on/off settings of the compulsory setting type functions are changed after the power of the vehicle 1 is turned on and before the power of the vehicle 1 is turned off.

Further, in an embodiment of the present disclosure, there is provided a program or a program product used for controlling the screen display of the display device 21 mounted in the vehicle 1, in which the functions assigned to the short cut buttons 35,36 which are displayed on the basic screen of the display device 1 is comprised of either the compulsory setting type functions which are compulsorily set on or off when the power of the vehicle 1 is turned on regardless of on/off settings of the functions when the power was turned off the previous time and the setting hold type functions where the on/off settings of the functions when the power was turned off the previous time are held when the power of the vehicle 1 is turned on, the program or a program product causing a computer to make the short cut buttons 35,36 to which the compulsory setting type functions are assigned be displayed on the basic screen of the display device 21 when the power of the vehicle 1 is turned on and keep the short cut buttons 35,36 to which the compulsory setting type functions are assigned from being displayed on the basic screen of the display device 21 until the power of the vehicle 1 is turned off when the on/off settings of the compulsory setting type functions are changed after the power of the vehicle 1 is turned on and before the power of the vehicle 1 is turned off.

Further, in an embodiment of the present disclosure, the compulsory setting type function is a function which is automatically turned on when the power of the vehicle 1 is turned on after the power of the vehicle 1 was turned off the previous time. Further, in an embodiment of the present disclosure, when the on/off setting of the compulsory setting type function is changed by the user after the power of the vehicle 1 is turned on and before the power of the vehicle 1 is turned off, instead of the short cut buttons 35,36 to which the compulsory setting type functions are assigned, the short cut buttons 35,36 to which separate functions are assigned are made to be displayed on the basic screen of the display device 21. In this case, the function with a high frequency of use from when the power of the vehicle 1 is turned on to when the power is turned off is made this separate function. Further, in an embodiment of the present disclosure, the short cut buttons 35,36 are formed so that the functions assigned to the short cut buttons 35,36 are switched between being set on and being set off each time the short cut buttons 35,36 are touched.

Next, another embodiment according to the present disclosure will be explained. In this other embodiment, in addition to for example the short cut button 35 to which the preselected specific compulsory setting type function is assigned, for example the short cut button 36 to which the function selected by the user is assigned is displayed on the basic screen of the display device 21. In this case, an additional means becomes necessary for the user to select the function to be assigned to the short cut button 36 and assign the selected function to the short cut button 36.

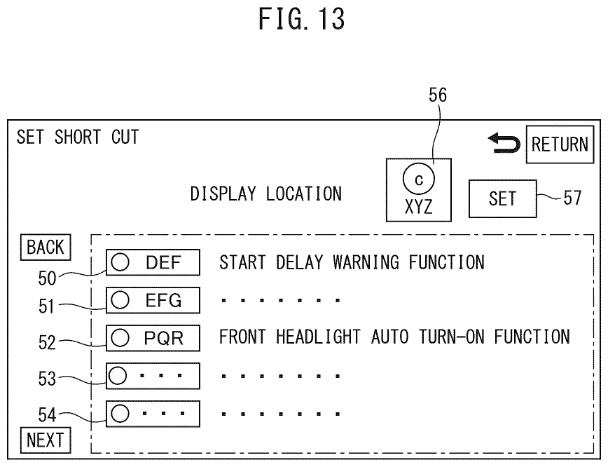

In this other embodiment, to display for example the short cut button 36 to which the function selected by the user is assigned on the basic screen of the display device 21, as shown in FIG. 12, a short cut setting button 34 is displayed on the basic screen of the display device 21 in addition to the various buttons 31, 32, and 33 shown in FIG. 3A. In this case, for example, when a road map is displayed on the basic screen of the display device 21 as shown in FIG. 12, if the short cut button 34 is touched, the road map is switched to the short cut setting screen positioned at one level below such as shown in FIG. 13. In the example shown in FIG. 13, candidates of functions which can be assigned to the short cut button 36 are displayed on the short cut setting screen. Further, the short cut setting buttons 50, 51, 52, 53, and 54 are displayed for the respective candidates of the functions displayed. Icons comprised of marks and letters are displayed on the respective short cut setting buttons 50, 51, 52, 53, and 54.

Note that the candidates of functions shown in FIG. 13, that is, the start delay warning function and the front headlight auto turn-on function are just some of candidates of functions listed on the short cut setting screen. In actuality, the short cut setting screen displays a far greater number of candidates of functions. In this case, in the example shown in FIG. 13, numerous candidates of functions extending over several pages are displayed. Further, in the example shown in FIG. 13, the short cut setting buttons 50, 51, 52, 53, and 54 of the candidates of the functions set on, that is, the candidates of the functions which are activated are displayed as on. For example, the short cut setting buttons 50, 51, 52, 53, and 54 of the candidates of the functions set on shine brightly at the short cut setting buttons 50, 51, 52, 53, and 54 as a whole or at the icon parts. The functions to be assigned to the short cut buttons 36 displayed on the basic screen of the display device 21 are selected by the user of the vehicle 1 from among the candidates of the functions listed on this short cut setting screen.

Further, in the example shown in FIG. 13, an icon 56 the same as the icon currently displayed at the short cut button 36 on the basic screen of the display device 21 is displayed on the short cut setting screen. For example, when the user of the vehicle 1 wants to assign the parking lot position display function (description is omitted in FIG. 13) to the short cut button 36, if the short cut setting button 54 of the parking lot position display function is touched and then a set button 57 is touched, the parking lot position display function is assigned to the short cut button 36. That is, the short cut button 36 to which the parking lot position display function selected by the user is assigned is displayed on the basic screen of the display device 21. If the parking lot position display function is assigned to the short cut button 36, the display and icon of the function which had been assigned to the short cut button 36 up to then are returned to the short cut setting screen and an icon showing the parking lot position display function is displayed on the short cut button 36. When the parking lot position display function finishes being assigned to the short cut button 36, after that, by just touching the short cut button 36 displayed on the basic screen of the display device 21, it becomes possible to switch between the on setting and off setting of the parking lot position display function.

In this way, in another embodiment of the present disclosure, the short cut button 36 to which the function selected by the user is assigned is displayed on the basic screen of the display device 21 in addition to the short cut button 35 to which the preselected specific compulsory setting type function is assigned. In this way, by making it possible to display the short cut button 36 to which the function selected by the user is assigned on the basic screen of the display device 21 in addition to the short cut button 35 to which the preselected specific compulsory setting type function is assigned, it becomes possible to display short cut buttons corresponding to the needs of the user and possible to improve the convenience to the user.

1. A display control device for controlling a screen display of a display device mounted in a vehicle, the display control device comprising:
a short cut button display control unit for making short cut buttons be displayed on a basic screen of the display device
functions assigned to the short cut buttons being comprised of either compulsory setting type functions which are compulsorily set on or off when a power of the vehicle is turned on regardless of on/off settings of the functions when the power was turned off the previous time and setting hold type functions where the on/off settings of the functions when the power was turned off the previous time are held when the power of the vehicle is turned on,
the short cut button display control unit making the short cut buttons to which the compulsory setting type functions are assigned be displayed on the basic screen of the display device when the power of the vehicle is turned on and keeping the short cut buttons to which the compulsory setting type functions are assigned from being displayed on the basic screen of the display device until the power of the vehicle is turned off when the on/off settings of the compulsory setting type functions are changed after the power of the vehicle is turned on and before the power of the vehicle is turned off.

2. The display control device according to claim 1, wherein the compulsory setting type function is a function which is automatically turned on when the power of the vehicle is turned on after the power of the vehicle was turned off the previous time.

3. The display control device according to claim 1, wherein when the on/off setting of the compulsory setting type function is changed by a user after the power of the vehicle is turned on and before the power of the vehicle is turned off, instead of the short cut buttons to which the compulsory setting type functions are assigned, the short cut buttons to which separate functions are assigned are made to be displayed on the basic screen of the display device.

4. The display control device according to claim 3, wherein the function with a high frequency of use from when the power of the vehicle is turned on to when the power is turned off is made said separate function.

5. The display control device according to claim 1, wherein the short cut buttons are formed so that the functions assigned to the short cut buttons are switched between being set on and being set off each time the short cut buttons are touched.

6. The display control device according to claim 1, wherein the short cut button display control unit makes the short cut button to which the function selected by a user is assigned be displayed on the basic screen of the display device in addition to the short cut button to which the compulsory setting type function is assigned.

7. A display control method for controlling a screen display of a display device mounted in a vehicle, in which functions assigned to short cut buttons which are displayed on a basic screen of the display device is comprised of either compulsory setting type functions which are compulsorily set on or off when a power of the vehicle is turned on regardless of on/off settings of the functions when the power was turned off the previous time and setting hold type functions where the on/off settings of the functions when the power was turned off the previous time are held when the power of the vehicle is turned on,
said display control method causing a computer to
make the short cut buttons to which the compulsory setting type functions are assigned be displayed on the basic screen of the display device when the power of the vehicle is turned on and
keep the short cut buttons to which the compulsory setting type functions are assigned from being displayed on the basic screen of the display device until the power of the vehicle is turned off when the on/off settings of the compulsory setting type functions are changed after the power of the vehicle is turned on and before the power of the vehicle is turned off.

8. A non-transitory computer-readable storage medium storing a program used for controlling a screen display of a display device mounted in a vehicle, in which functions assigned to short cut buttons which are displayed on a basic screen of the display device is comprised of either compulsory setting type functions which are compulsorily set on or off when a power of the vehicle is turned on regardless of on/off settings of the functions when the power was turned off the previous time and setting hold type functions where the on/off settings of the functions when the power was turned off the previous time are held when the power of the vehicle is turned on,
said program causing a computer to
make the short cut buttons to which the compulsory setting type functions are assigned be displayed on a basic screen of the display device when the power of the vehicle is turned on and
keep the short cut buttons to which the compulsory setting type functions are assigned from being displayed on the basic screen of the display device until the power of the vehicle is turned off when the on/off settings of the compulsory setting type functions are changed after the power of the vehicle is turned on and before the power of the vehicle is turned off.
